(19) United States
(12) Patent Application Publication
(10) Pub. No.: US 2023/0399198 A1
(43) Pub. Date: Dec. 14, 2023

(54) STIMULATION SYSTEM AND METHOD FOR MONITORING AN ELEVATOR SYSTEM

(71) Applicant: Otis Elevator Company, Farmington, CT (US)

(72) Inventors: Gabriel Vaudour, Mardié (FR); Franck J. Det, Gien (FR); Bruno Beignet, Gien (FR)

(21) Appl. No.: 17/977,012

(22) Filed: Oct. 31, 2022

(30) Foreign Application Priority Data
Jun. 8, 2022 (EP) 22305829.8

(51) Int. Cl. B66B 5/00; B66B 1/34; B66B 1/06; B66B 13/14; B66B 3/00; B66B 5/02

(52) U.S. Cl. CPC B66B 5/0018; B66B 1/3461; B66B 1/06; B66B 13/146; B66B 3/002; B66B 5/02

(57) ABSTRACT

A stimulation system (301) for monitoring an elevator system, including a main controller (302) having a trigger output (312) for sending trigger signals and configurable to receive detection signals from sensors of the elevator system, and an activation controller (304) connectable to a input unit of an elevator car and having a trigger input (316) for receiving trigger signals that is connected to the trigger output; the activation controller is configured to, when connected to the input unit, cause activation, in response to a trigger signal (406), of predetermined operational signals at the input unit; and the main controller is configured to, when configured to receive the detection signals from the sensors, send (404) the trigger signal, and determine based on detection signals whether at least one change of the operating state occurs in accordance with the at least one predetermined operational signal.

### FOREIGN PRIORITY

This application claims priority to European Patent Application No. 22305829.8, filed Jun. 8, 2022, and all the benefits accruing therefrom under 35 U.S.C. § 119, the contents of which in its entirety are herein incorporated by reference.

### TECHNICAL FIELD

This disclosure generally relates to a stimulation system and method for (autonomously) monitoring an elevator system and in particular detecting operability or non-operability, such as a hard shutdown, of an elevator car.

### BACKGROUND OF THE INVENTION

Elevator systems may be monitored remotely to provide useful information for the operating elevator company and the fleet building manager. The essential information required by them is to know whether each elevator is operational or not (hard shutdown). Specifically, elevator systems may be monitored in a number of ways in order to establish characteristics relating to the operational health of the elevator system. Some characteristics of particular interest are those relating to travel of the elevator car within the hoistway. Other characteristics of particular interest are those relating to operation of the elevator car door(s) while the elevator car is at a landing.

### SUMMARY

According to aspects of this disclosure provided are a stimulation system for monitoring an elevator system, an elevator system, and a stimulation method for monitoring an elevator system.

The stimulation system for (e.g. autonomously) monitoring an elevator system, which elevator system has an elevator car with an input unit for providing operational signals to an elevator controller of the elevator system and which elevator system has sensors for detecting an operating state of the elevator car and outputting corresponding detection signals comprises a main controller having a trigger output for sending trigger signals and configurable (i.e. the main controller) to receive the detection signals from the sensors, and an activation controller having a trigger input for receiving trigger signals, the trigger input connected to the trigger output of the main controller and the activation controller being connectable to the input unit of the elevator car. The activation controller is configured to, when connected to the input unit, cause, in response to a trigger signal received on the trigger input, activation of predetermined operational signals at the input unit. The main controller is configured to, when configured to receive the detection signals from the sensors, send the trigger signal over the trigger output, and determine based on the detection signals whether at least one change of the operating state occurs in accordance with the at least one predetermined operational signal.

Accordingly, a functional test is initiated, wherein upon the trigger signal, the activation of predetermined operational signals at the input unit is triggered and performed autonomously, e.g. without any further interaction between the main controller and the activation controller or any command or signal from a device outside the stimulation system. For example, this activation is performed independently by the stimulation system. This allows for a simple and reliable structure of the activation controller and is achieved without any remote command from a computing entity remote from the elevator system. For example, other than the trigger input, no communication interface is necessary on the activation controller. The activation controller may optionally be used in combination with an existing programmable main controller (e.g. a main controller already arranged in the elevator car and used for other purposes as well) that has an output that is configurable as trigger output. For example, this allows for retrofitting.

According to aspects the of the present disclosure, the stimulation system (and also the stimulation method) may autonomously provide a simulation of an elevator usage by a passenger (e.g. door opening request, destination entry/entries). The stimulation system and specifically the activation controller can be seen as an autonomous device. Added to sensors to detect the elevator motion (doors movements, car movements), it allows a person or remote monitoring system to know if the elevator is operational (no hard shutdown)

Specifically, the stimulation system provides a hard shutdown detection (e.g. to know if the elevator is operational or not) for old elevator systems or for elevator systems, in which communication with the elevator controller is not possible. For example, elevator systems having installed a (e.g. programmable) main controller, which is configured for receiving detection signals from sensors, may additionally be provided (or retrofitted) with the activation controller (and e.g. connected to the input unit of the elevator car). The main controller may than be reprogrammed in order to implement the stimulation system and method. In another example, the main controller and the activation controller may be installed into an already existing elevator system (and e.g. connected to sensors and to the input unit of the elevator car).

The main controller may be configured to generate the trigger signal autonomously, i.e. the trigger signal is generated by the main controller itself without receiving a command (such as e.g. a command to start the monitoring procedure) from another device (such as e.g. a remote computing entity, in particular remote from the elevator system, or the elevator controller).

In an example, the main controller may further be configured to, when configured to receive the detection signals from the sensors, determine based on the detection signals, that since the last use of the elevator car a specified dead time has elapsed, and send the trigger signal when it is determined that the specified dead time has elapsed since the last use. Accordingly, no external signal is necessary to start the functional test. The dead time may be chosen appropriately. For example (e.g. to ensure that, if the elevator car is not used, a functional test is performed at least once a day), the dead time may be in the range of hours, such as in the range from 1 h to 23 h, in the range from 2 h to 20 h, in the range from 4 h to 15 h, or in the range from 6 h to 10 h. In another example the dead time may be in the range of days, such as in the range from 1 day to 7 days, in the range from 1 day to 4 days, or in the range from 2 days to 3 days. Other time periods are possible as well, e.g. the dead time may be in the range from 1 week to 4 weeks or in the range from 1 month to 12 months.

In an example, the activation controller is configured to, when connected to the input unit, cause the activation of some or all of the predetermined operational signals in a predetermined sequence such that between each two consecutive of the operational signals of the predetermined sequence a respective delay time period is present. Accordingly, operational signals are activated in a delayed manner with respect to each other, such that proper function of the elevator car can be ensured, which may depend on the order the operational signals. The delay time periods may be chosen independently of each other. Each of the delay time periods may be in the range from 0.1 s to 20 s, in the range from 0.5 to 15 s, or in the range from 1 s to 10 s, for example.

In an example, the activation controller comprises a delay circuit connected to the trigger input and activation elements connected to the delay circuit; the activation elements connectable to the input unit, wherein the delay circuit is configured to generate operational commands in response to receiving the trigger signal, wherein each operational command changes a state of one of the activation elements such that, when connected to the input unit, activation of a corresponding one of the operational signals is caused; and wherein at least one of the operational commands is generated with a time delay with respect to the trigger signal. It should be noted that the time delay of the operational commands should be understood as a delay in addition to the signal propagation time through the delay circuit. For example, the time delay of the at least one of the operational signals may be greater than 0.1 s (seconds), or greater than 0.5 s. Optionally, the time delay of the at least one of the operational signals may be in the range from 0.1 s to 60 s, in the range from 0.5 s to 40 s, or in the range from 1 s to 30 s.

In an example, at least two of the at least one of the operational commands generated with time delay with respect to the trigger signal are generated with different time delays with respect to the trigger signal. For example, all operational commands, or all but one operational commands, may be generated with time delays with respect to the trigger signal, such that each operational command has a different time delay. According to another example, all operational commands with the exception of one operational command may be generated with time delays with respect to the trigger signal, such that each operational command has a different time delay.

It will be appreciated that the time periods and the delay times of the previous examples are typically implemented by hardware elements on the activation controller, which hardware elements delay the signals (delay elements).

In an example, the at least one predetermined operational signal comprises one or more of a door opening signal, a drive signal to a first floor, a drive signal to a second floor different from the first floor, an access signal for enabling access to the elevator car, and an access signal for disabling access to the elevator car.

In an example, the at least one predetermined operational signal comprises the door opening signal and at least one of the drive signal to the first floor and the drive signal to the second floor; wherein the activation controller is configured to cause the activation of the door opening signal prior to the activation of the at least one of the drive signal to the first floor and the drive signal to the second floor.

In an example, the main controller comprises at least one sensor input connectable to one or more of the sensors. The sensors may comprise one or more of at least one door sensor, and at least one car position indicator.

In an example, each of the at least one change of the operating state is associated with one or more of the at least one predetermined operational signals.

In an example, the main controller is further configured to generate an error message, when it is determined that the at least one change of the operating state does not occur in accordance with the at least one predetermined operational signal, and, optionally, send the error message to a (first) remote computing entity. The error message may include information as to which one of the at least one change in the operating state did not occur.

In an example, the main controller is further configured to generate a success message, when it is determined that the at least one change of the operating state does occur in accordance with the at least one predetermined operational signal; and, optionally, send the success message to a (second) remote computing entity. The second remote computing entity may be the same as the first remote computing entity or may be different from the first remote computing entity.

The first and second remote computing entities may be a computer, a computer system, a cloud system, or a cloud service, for example. The first and second remote computing entities may be remote from the elevator car (e.g. an elevator system server in the building, e.g. accessible by a building manager) or even remote from the elevator system (e.g. external to the building, e.g. a cloud server accessible by a service company). In some examples, a communication gateway or the like may be provided in the elevator system, which is connected or connectable (by wire and/or in a wireless manner) to the main controller and the first and/or second remote computing entities for exchange of data. In some examples, the main controller includes a direct or indirect connection to the first and/or second remote computing entities via a telecommunications network.

In an example, the at least one change of the operating state includes a first change of the operating state and a second change of the operating state; wherein the main controller is further configured to, when configured to receive the detection signals from the sensors, monitor, after sending the trigger signal, the detection signals for a specified first monitoring time period whether the first change of the operating state occurs (wherein optionally the first monitoring time period starts from the trigger signal, or may start with a time delay from the trigger signal), monitor, after sending the trigger signal, the detection signals for a specified second monitoring time period whether the second change of the operating state occurs, wherein the second monitoring time period is longer than the first monitoring time period (wherein optionally the first monitoring time period starts from the trigger signal), and determine, when the first change of the operating state does not occur during the first monitoring time period, that the first change of the operating state occurs not in accordance with the at least one predetermined operational signal, and stop monitoring whether the second change of the operating state occurs.

The elevator system comprises an elevator controller and an elevator car with an input unit for providing operational signals to the elevator controller, the elevator system having sensors for detecting an operating state of the elevator car and outputting corresponding detection signals. The elevator system further comprises a stimulation system according to aspects of the present disclosure, wherein the main controller is configured to receive the detection signals and the activation controller is connected to the input unit.

In any of the examples disclosed herein, the input unit may comprise one or more of: a card reader, a set of destination input buttons, a destination call panel (e.g. a touchscreen display), a gesture command sensor, or any other suitable device for recognising a passenger input relating to travel of the elevator car.

In any of the examples disclosed herein, the sensors may comprise one or more of: a door sensor (e.g. arranged to sense door opening and/or closing), a car position indicator, a car speed sensor, an accelerometer mounted to the elevator car.

The stimulation method for (e.g. autonomously) monitoring an elevator system comprises: sending, by a main controller, a trigger signal; receiving, by an activation controller, the trigger signal; causing, by the activation controller, activation of redetermined operational signals at the input unit in response to the trigger signal; receiving, by the main controller, the detection signals from the sensors; and determining, by the main controller, based on the detection signals whether at least one change of the operating state occurs in accordance with the at least one predetermined operational signal.

It will be appreciated that all of the optional or example features discussed above in relation to the stimulation system can equally optionally apply to this stimulation method of monitoring an elevator system.

### BRIEF DESCRIPTION OF DRAWINGS

FIG. 1 is a schematic illustration of an elevator system according to examples of the present disclosure;

FIG. 2 is a schematic illustration of an elevator car according to examples of the present disclosure;

FIG. 3 is a schematic illustration of a stimulation system according to examples of the present disclosure;

FIGS. 4A, 4B are flow charts illustrating an exemplary monitoring process;

FIG. 5 depicts an exemplary timing diagram for performing monitoring of an elevator.

### DETAILED DESCRIPTION

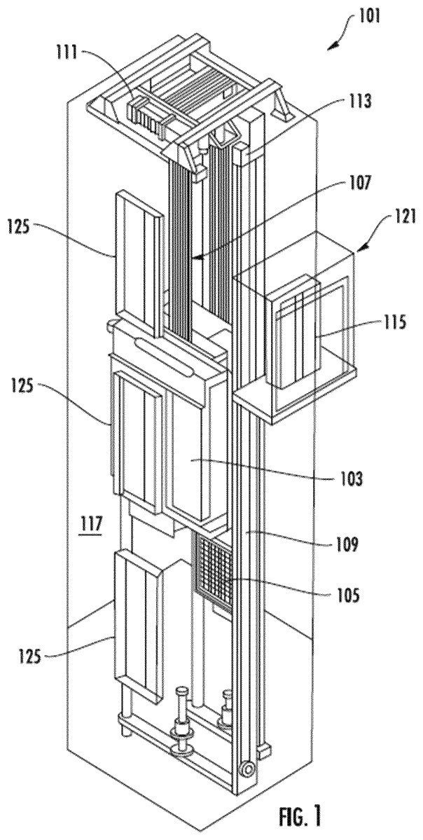

FIG. 1 is a perspective view of an elevator system 101 including an elevator car 103 (also denoted as car), a counterweight 105, a tension member 107, a guide rail 109, a machine 111, a position reference system 113, and an elevator controller 115 (such as a controller of the elevator system). The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, levelling, stopping, etc. of the elevator car 103. The elevator controller 115 may also be configured to receive position signals from the position reference system 113 or any other desired position reference device. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101. In one embodiment, the elevator controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor or pinched wheel propulsion to impart motion to an elevator car. Embodiments may also be employed in ropeless elevator systems using a hydraulic lift to impart motion to an elevator car. FIG. 1 is merely a non-limiting example presented for illustrative and explanatory purposes.

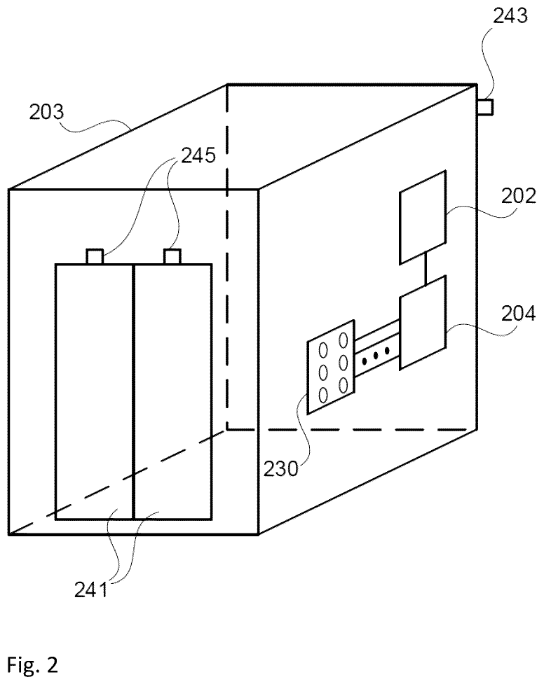

FIG. 2 is a schematic illustration of an elevator car 203 (also denoted as car) according to examples of the present disclosure. The elevator car 203 has doors 241 and an input unit 230. The input unit 230 has input elements, such as buttons, on the inside of the elevator car for receiving input from a user of the elevator. The user input is typically output by the input unit to the controller of the elevator system (e.g. elevator controller 115 of FIG. 1) as an operational signal and the elevator controller of the elevator system effects the corresponding operation. The positioning of the sensors in FIG. 2 is only exemplary. Door sensors 245 and a car position indicator 243 (e.g. working in combination with position reference system 113) are shown in FIG. 2. Door sensors 245 and a car positon indicator 243 are exemplary sensors for detecting an operating state of the elevator. The sensors may be arranged differently and placed at other than the shown positions. Further, the sensors or at least parts of the sensors may not be placed on the elevator car but on other elements of the elevator system, such as position reference system 113 in FIG. 1.

In FIG. 2 there is shown a stimulation system for the elevator car 203, generally comprising a main controller 202 and an activation controller 204. The main controller 202 may be configured to generate trigger signals and is connected to the activation controller 204 for sending trigger signals to the activation controller 204. The activation controller 204 is connected to the input unit 230 in order to cause activation of predetermined operational signals in response to receiving a trigger signal. In some examples the activation controller 204 (and optionally the input unit 230) may be added or retrofitted and connected to an already existing main controller 202, for example if the elevator system was installed by one manufacturer and another company takes over responsibility for service and monitoring. The activation controller 204 provides a way for the service company to trigger operational signals at the input unit 230 to stimulate test conditions and then monitor how the elevator car reacts. The existing main controller 202 may be reprogrammed in order to implement the procedure of the present application, i.e. to perform the steps of the procedure of the present application that are performed by the main controller.

While in FIG. 2 the main controller and the activation controller are drawn on a side wall, for example, they may in general be arranged at other positions of the elevator car independently of each other, such as in or on other side walls, or in or on top or bottom walls of the elevator car.

The stimulation system for autonomously monitoring an elevator system as depicted in FIG. 2, for example, may be considered as an embedded monitoring system; i.e. as a monitoring system that is embedded in the elevator car (or elevator system) and does not rely on input or commands from outside the elevator car (or elevator system) in order to perform a functional test of the elevator system.

In some examples (different from the example shown in FIG. 2), the main controller may be arranged outside or remote from the elevator car. In that case only the activation controller is arranged in the elevator car. For example, the main controller may be part of the elevator controller or its functionality may be provided by the elevator controller. In that case only the activation controller is arranged in the elevator car and the elevator controller may be seen as main controller.

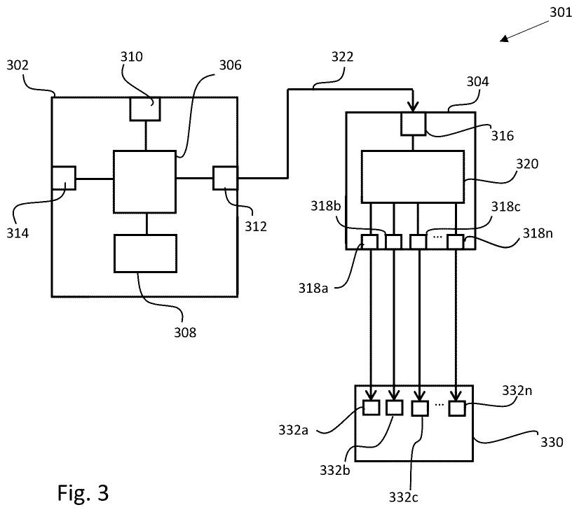

FIG. 3 is a schematic illustration of a stimulation system 301 according to examples of the present disclosure. The stimulation system 301 includes a main controller 302 and an activation controller 304.

The main controller 302 may include a processor 306 and a memory 308. The processor 306 may have one or more computing cores for executing program instruction stored in the memory 308. The memory 308 may include one or more volatile memory, such as random access memory (e.g. SRAM or DRAM). The memory 308 may further include one or more non-volatile memory, such as a solid state memory (e.g. a flash memory in a NAND or a NOR configuration). The main controller 302 may further include a communication interface 314 for communication (i.e. exchange of data) with a remote computing entity, such as a remote computer, a remote computing entity, or a cloud system. In examples the communication interface 314 may be configured to connect to a communications gateway of an elevator system in which the stimulation system 301 is installed. Such a connection to the gateway may be a wired connection or a wire-less connection. In this example, the communications gateway in turn may be configured for communication with remote computing entities.

The main controller 302 may include one or more sensor input(s) 310 configured to receive detection signals from sensors of an elevator car, such as door sensors and car position indicators (e.g. the position reference system 113 of FIG. 1). That is, the main controller 302 is configurable to receive detection signals from sensors of an elevator car. In some examples, the main controller 302 may be configurable to receive detection signals from sensors of the elevator system, including from sensors arranged at least partially on other elements of the elevator system than the elevator car. Alternatively or additionally to using sensor input(s) 310, it is possible to configure the main controller 302 such that detection signals of sensors may be received through the communication interface 314.

The main controller 302 is configured to generate trigger signals and includes a trigger output 312 configured to send the trigger signals to the activation controller. The trigger output 312 may be an arbitrary interface. In particular, a GPIO (general-purpose input/output; e.g. a pin whose output voltage level may be set directly by the processor, i.e. a program executed by the processor) may be used as trigger output 312.

The activation controller 304 includes a trigger input 316 configured to receive trigger signals. The trigger output 312 of the main controller may be connected to the trigger input 316 of the activation controller 304 by an electric line 322 (the arrow indicating the direction of the trigger signal), for example.

The activation controller 304 may include a delay circuit 320. The delay circuit 320 may be configured to receive the trigger signal (directly or indirectly from the trigger input) and to generate or output operational commands for activation elements 318a, 318b, 318c, . . . 318n. The activation elements 318a, 318b, 318c, . . . 318n may be switches, such as relays or semiconductor switches (e.g. transistors). Correspondingly, the operational commands may consist in setting or changing a voltage level or a sequence of voltage levels applied at a control terminal or control gate of the respective switch (activation element). The other terminals of the switch may be connected to the input unit by electric lines. Particularly, this implies that the activation controller can be used for different input units having different voltage levels (or the like) for the operational signals, as these voltage levels are provided by the input unit.

The activation elements 318a, 318b, 318c, . . . 318n are connectable to respective input elements (such as buttons or a card reader of an access control) of an input unit 330 of an elevator car (inside the elevator car). In the example shown in FIG. 3 the activation elements 318a, 318b, 318c, . . . 318n are connected to respective input elements 332a, 332b, 332c, . . . 332n of the input unit. Each of the activation elements 318a, 318b, 318c, . . . 318n, when controlled accordingly by the delay circuit using the operational commands, causes activation of the same operational signal that would be activated if the respective input element would be used by a user (e.g. a button pressed by the user or a security card presented to a card reader). Each of the activation elements 318a, 318b, 318c, . . . 318n, such as switches, may bridge the respective input element 332a, 332b, 332c, . . . 332n.

An operational signal is a signal that may be provided by the input unit to a controller of the elevator system (e.g. elevator controller 115 of the elevator system 101 shown in FIG. 1) in order to effect operation of the elevator car according to the operational signal. In some examples, an operational signal may effect operation of elements not part of the elevator car as well, such as doors on landings. It should be noted that the input unit 330 is not necessarily part of the stimulation system 301 as such, rather, the stimulation system is connectable/connected to the input unit of the elevator car in order to provide its monitoring functionality, e.g. the stimulation system is connected to an input unit already installed in the elevator car.

For example, input element 332a may be a button for opening the doors of the elevator car and/or the elevator system, input element 332b may be a button for a first floor, input element 332c may be a button for a second floor, and input element 332n may be a card reader of an access control. The terms ‘first floor’ and ‘second floor’ are used to distinguish two different floors, they do not necessarily refer to a ‘floor number 1’ and a ‘floor number 2’ of a numbering of floors of the elevator system.

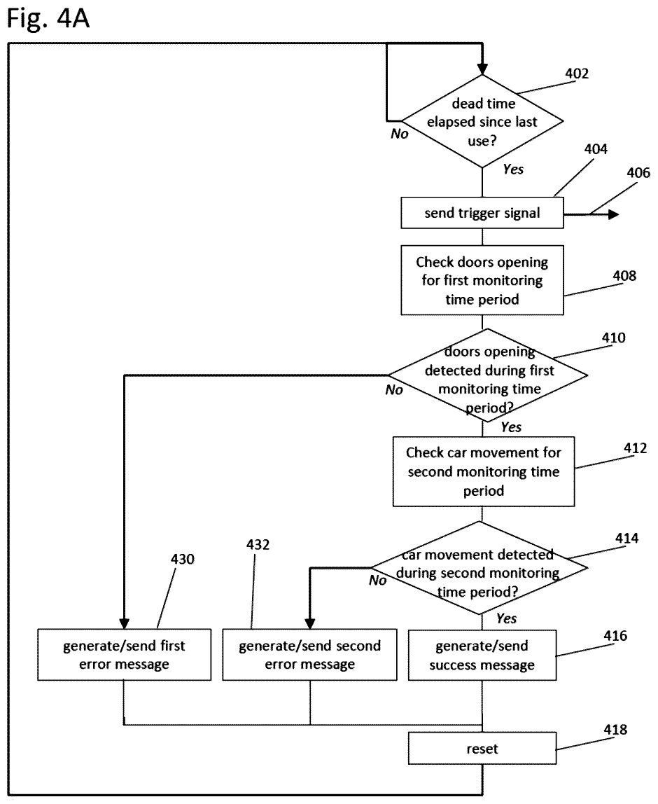

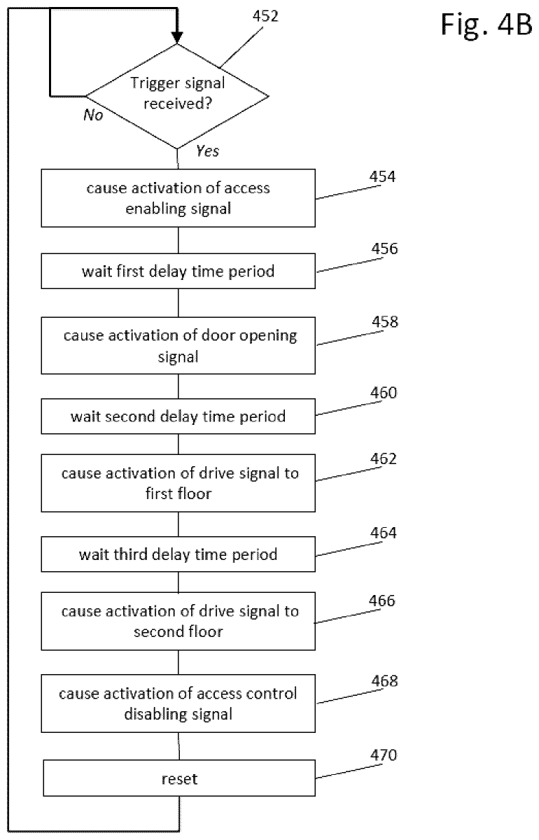

FIGS. 4A, 4B are flow charts illustrating an exemplary monitoring process. FIG. 4A relates to steps being performed by the main controller of the stimulation system (e.g. the main controller 302 as shown in FIG. 3), FIG. 4B relates to steps being performed by the activation controller of the stimulation system (e.g. the activation controller 304 as shown in FIG. 3).

The main controller is typically programmable, accordingly steps performed in the main controller may be reprogrammed, e.g. time periods, such as the dead time and/or monitoring time periods, may be set to different values and/or steps different from the shown exemplary implementation may be programmed.

The activation controller is typically implemented by hardware elements, accordingly it may not be possible to change operational commands generated by the activation controller and/or activated operational signal and/or timings thereof after production. Different from the shown predetermined operational signals and timings may be implemented by choosing the hardware elements accordingly. The implementation by hardware elements has the advantage that it can be easily implemented at low costs.

In step 402 the main controller determines (monitors) whether a specified dead time has elapsed since the last use of the elevator car, i.e. whether an elevator operation (such as an opening of the doors or a movement of the elevator car) has taken place during the dead time. This determination is performed based on detection signals received from the sensors. For example, based on detection signals it may be determined if the doors of the elevator car have opened during the dead time or if the floor of the elevator car has changed indicating a car movement. When a use (elevator operation) is determined during the dead time, i.e. prior to its completion, the time of the last use or a timer measuring the dead time may be reset accordingly.

When in step 402 it is determined that the dead time has elapsed (‘Yes’), a trigger signal 406 is (generated and) sent to the activation controller in step 404, i.e. the trigger signal is provided by the main controller on its trigger output. If the dead time has not elapsed (‘No’) step 402 is continued.

The further steps may be seen as steps of a functional test of the elevator system and specifically of the elevator car, which functional test is performed in response to a timing signal, i.e. in the present example in response to the elapse of the dead time.

Referring to the activation controller (see FIG. 4B), in step 452 the trigger input is monitored as to whether the trigger signal is received, i.e. whether the trigger signal is detected on the trigger input. If not (‘No’), step 452 may be continued. When the trigger signal is detected on the trigger input (‘Yes’), activation of predetermined operational signals is caused by the activation controller in sequence, wherein between consecutive of the predetermined operational signals delay times are included. In the following it is assumed, that the activation controller is connected to the input unit.

In step 454 the sequence may start with enabling access to the elevator car and generally to operating the elevator system, i.e. an access command for enabling access to the elevator car is generated, such that an access signal for enabling access to the elevator car is activated at the input unit. This refers to a case in which the elevator car has an access control, such as a security card reader, which allows operation of the elevator car only when the access is enabled. The expression ‘access to the elevator car’ may be understood in sense of allowing operation of the elevator car (e.g. opening of doors or driving to a different floor). The access command for enabling access to the elevator car may be a change of a voltage level (e.g. from low to high or from high to low) which controls an activation element (such as a switch, a relay, a semiconductor switch, or a transistor) that is connected or connectable to the access control. The change of the state of the switch may activate (generate) the same operational signal that is activated when the normal access control is realised, e.g. when the security card reader detects a valid security card.

After enabling access in step 454 the process may wait for a first delay time period (e.g. 1 s) in step 456. In step 458, after completion of the first delay time period, a door opening command which causes activation of a door opening signal, i.e. of the signal that is activated (generated) when the door opening button is pressed on the input unit. In step 458 the door opening command and correspondingly the door opening signal may be held for a certain time, such as a first activation time (e.g. 1 s).

After step 458 the process may wait for a second delay time period (e.g. s) in step 460. In step 462, after completion of the second delay time period, a drive command to a first floor which causes activation of a drive signal to the first floor, i.e. of the signal that is activated (generated) when the floor button for the first floor is pressed on the input unit. In step 462 the drive command to the first floor and correspondingly the drive signal to the first floor may be held for a certain time, such as a second activation time (e.g. 1 s).

After step 462 the process may wait for a third delay time period (e.g. 5 s) in step 464. In step 466, after completion of the second delay time period, a drive command to a second floor which causes activation of a drive signal to the second floor, i.e. of the signal that is activated (generated) when the floor button for the second floor is pressed on the input unit. In step 466 the drive command to the second floor and correspondingly the drive signal to the second floor may be held for a certain time, such as a third activation time (e.g. 1 s).

After step 466, in step 468 the sequence may end with disabling access to the elevator car, i.e. an access command for disabling access to the elevator car is generated, such that an access signal for disabling access to the elevator car is activated at the input unit. The access command for disabling access to the elevator car may be a change of the voltage level (opposed to the change in step 454) which controls a switch that is connected or connectable to the access control. The change of the state of the switch may activate (generate) the same operational signal that is activated for disabling access when the normal access control is realised, e.g. when the security card reader fails to a valid security card.

In step 470 (after step 468) the activation controller may reset to a default state and the process may be continued with step 452, i.e. the monitoring of the trigger input. The activation controller is typically configured such that trigger signals that are received during execution of steps 454 to 468 are ignored, i.e. do not interrupt the execution of these steps or restart the sequence at step 454. For example, step 452 may only be performed when the activation controller is in the default state.

In FIG. 4B delay time periods between the activation of consecutive operational signals are implemented by including waiting times (steps 456, 460, 464). Alternatively, such delay time periods may be implemented by waiting times starting with receiving the trigger signal (‘Yes’ in step 452). In that case for each of the consecutive operational signals a waiting time may be chosen, such that the delay time periods between the activation of consecutive operational signals are achieved.

It will be appreciated that the set of operational signals shown in FIG. 4B is only exemplary. A different set having different, less, or additional operational signals may be implemented by the activation controller. Delay time periods between consecutive operational signals may be chosen to have different values from the indicated exemplary values or may not to be present (as far as consistent with the structure of the elevator system). Activation times of the operational signals may be chosen to have different values from the indicated exemplary values.

Referring to the main controller (see FIG. 4A), after sending the trigger signal in step 404, the main controller may monitor (check) whether the doors are opening for a first monitoring time period (e.g. 15 s) in step 408. This is done based on the detection signal of sensors, such as door sensors. In step 410 it is determined whether or not the doors have opened during the first monitoring time period.

When it is determined in step 410 that the doors have not opened during the first monitoring time period (‘No’), in step 430 a first error message may be generated or output and for example be sent to a remote computing entity. The first error message indicates for example that the doors have not opened and may include further information such as a time stamp, a time indicating the time the elevator car has last been used, or other information on the state of the elevator car. The first error message in particular is an indicator that the elevator car may have shut down with the risk of a passenger being trapped in the car (“hard shutdown with risk of passenger being trapped”).

When it is determined in step 410 that the doors have opened during the first time period (‘Yes’), the process may continue with step 412, in which the main controller may monitor (check) whether the elevator car has moved for a second monitoring time period (e.g. 60 s), i.e. whether a car movement occurs during the second monitoring time period. This may be done based on detection signals from the sensors, e.g. from car position indicators, wherein a change of the car position indicates the elevator car has moved. The second time period may start at the same point in time as the first time period, i.e. after step 404 (sending the trigger signal). In step 414 it is determined whether or not a car movement has occurred during the second time period.

When it is determined in step 414 that no car movement has occurred during the second monitoring time period (‘No’), in step 432 a second error message may be generated or output and for example be sent to the remote computing entity. The second error message indicates for example that no car movement has occurred and may include further information such as a time stamp, a time indicating the time the elevator car has last been used, or other information on the state of the elevator car. The first error message in particular is an indicator that the elevator car may have shut down without the risk of a passenger being trapped in the elevator car (“hard shutdown without risk of passenger being trapped”).

When it is determined in step 414 that a car movement has occurred during the second time period (‘Yes’), in step 416 a success message may be generated or output and for example be sent to the remote computing entity. The success message indicates for example the functional test (i.e. the process shown in FIGS. 4A, 4B) has been performed successfully and may include further information such as a time stamp, a time indicating the time the elevator car has last been used, or other information on the state of the elevator car.

After each of steps 416, 430, 432, the timing parameters, such as the dead time, the first monitoring time period, and the second monitoring time period, may be reset in step 418 and the process may continue with step 402.

It will be appreciated that instead or additionally to sending separate error messages (first and second error messages) in steps 430, 432 a combined error massage may be generated or output and optionally sent to a remote computing entity after step 414, which error message indicates that the doors have not opened during the first time period and/or that no car movement has occurred during the second time period. That is, after step 414 either the success message or the combined error message may be generated or output and optionally sent to a remote computing entity.

The first, second, and combined error messages are examples for an error message that is generated (or output) by the main controller and optionally sent to a remote computing entity when it is determined based on the detection signals that the operating state of the elevator car does not change in accordance with the predetermined operational signals. The error message, such as the first, second, and combined error messages, may include information that indicates which change of the operating state did not occur. Such information facilitates the analysis of the error and indicates the urgency of a reaction to the error message (e.g. if there is the possibility of a passenger being trapped in the elevator car).

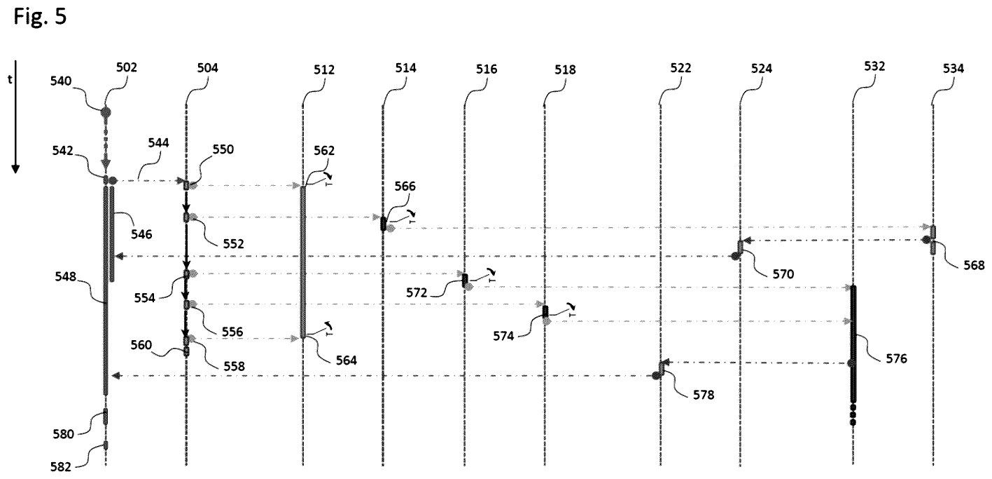

FIG. 5 depicts an exemplary timing diagram for performing monitoring of an elevator car (and generally of the elevator system). In the figure it is assumed that the elevator system is functioning properly (as far as the functions tested by the stimulation system are concerned). In the diagram time t extends from top to bottom and columns show activities being performed by or taking place in different elements of the elevator system (e.g. as shown in FIG. 1).

Columns 502 and 504 relate to the timing of steps performed in the stimulation system (such as the stimulation system shown in FIG. 2). Specifically, column 502 relates to the main controller and column 504 relates to the activation controller.

Operational signals at the input unit are shown as follows: column 512 relates to an access control signal, column 514 relate to door open signal, column 516 relates to a drive signal to a first floor (e.g. ‘Floor 1’ or any other floor in a numbering of the floor of a building in which the elevator system is incorporated), and column 518 relates to a drive signal to a second floor (e.g. ‘Floor 2’) different from the first floor. It should be noted that the terms ‘first’/‘second’ floor merely serve to distinguish two different floors, they do not necessarily relate to a numbering of the floors.

Columns 522 and 524 are related to sensors and detection signals (detection data) thereof. For example, column 522 shows detection signals of a car position indicator (car position sensor) and column 524 shows detection signals of door sensors.

Further, the behaviour of the elevator car is depicted in column 532, which shows the movement of the elevator car, and in column 534, which shows movement of doors.

In the example shown in FIG. 5, at a certain time, starting time 540, a timer may be started by the main controller, which after a determined dead time (i.e. a determined time period) stops at a testing time 542. The starting time 540 may coincide with a certain predetermined event, such as the time of the last elevator car activity (e.g. closing or opening of the doors), in which case the timer is reset when an elevator car activity is detected during the dead time, or such as the time of receiving a remote command for starting the timer. Alternatively or additionally, the starting time 540 may be one or more predetermined time, such as a certain point of time each day or each week, or the like.

At the testing time 542 a functional test of the elevator car is initiated by the main controller. While in FIG. 5 the testing time 542 is determined as the point of time at which the dead time ends after the starting time 540, it will be appreciated that in general the testing time 542 may be determined by any generic timer. For example, the testing time 542 may be one or more predetermined time, such as a certain point of time each day or each week, or the like. The testing time 542 may also be determined as the time at which a (remote) testing command is received at the main controller.

At the testing time 542, that is at the start of the functional test, a trigger signal 544 is sent from the main controller (which generates the trigger signal) to the activation controller. The trigger signal 544 may extend over a certain time period (e.g. 1 s). Further, at the testing time 542, or after a time delay (e.g. 1 s), or after the trigger signal 544 has stopped monitoring of sensor inputs of the main controller is started for receiving feedback (detection signals) from the sensors. The sensor inputs are connected to the sensors, for example, to the car position indicator and the door sensors. Time periods (also denoted monitoring time periods) during which the sensor inputs are monitored for feedback after the start of the monitoring may be set (e.g. according to a programming of the main controller) individually or at least partially commonly for the sensor inputs. For example, a first monitoring time period 546 (e.g. 15 s) for monitoring detection signals from door sensors and a second monitoring time period 548 (e.g. 60 s) for monitoring detection signals from the car position indicator are shown.

In reaction to receiving the trigger signal 544 the activation controller may cause the input unit to generate at least one predetermined operational signal. The activation controller may be configured such that this reaction (i.e. causing the provision of at least one predetermined operational signal by the input unit) to receiving the trigger signal is only triggered when the activation controller is in a predetermined default state. For example, as discussed in relation to FIG. 3, operational commands may be generated in the activation controller which cause corresponding activation elements of the activation controller to cause activation of the operational signal corresponding the respective operational command (as indicated by schematic switches in FIG. 5).

In the example shown in FIG. 5 an access command 550 for enabling access to the elevator car, a door opening command 552, a drive command 554 to the first floor, a drive command 556 to the second floor different from the first floor, and an access command 558 for disabling access to the elevator car are generated as operational command Each operational command may be provided over a certain period of time (e.g. 1 s), which may be different for different operational commands. These periods of time may be determined based on electrical properties of the input unit, such as a hold time for a signal to be registered.

The operational commands are provided in a sequence, wherein between two consecutive operational commands of the sequence predetermined delay time periods are present. Delay time periods of different pairs of consecutive operational commands may be different. The delay time periods may be chosen based on the operation of the elevator car that is effected by the respective operational signal. For example, a delay time period between the access command 550 for enabling access to the elevator car and the door opening command 552 may be 1 s, a delay time period between the door opening command 552 and the drive command 554 to the first floor may be 5 s, a delay time period between the drive command 554 to the first floor and the drive command 556 to the second floor may be 1 s, a delay time period between the drive command 556 to the second floor and the access command 558 for disabling access to the elevator car may be 2 s.

It will be appreciated that the set of operational commands shown in FIG. 5 and the set of the corresponding operational signals is only exemplary. A different set of operational commands (or signals) having different, less, or additional operational commands (or signals) may be used. This may depend on the structure of the elevator system. For example, if the elevator car has no access control, the access command and access signal for enabling access to the elevator car and access command and access signal for disabling access to the elevator car may not be provided.

The sequence of providing the door opening command 552 before the drive commands 554, 556 is, for example, advantageous in case the elevator car or the input unit is configured to stop monitoring input from floor buttons inside the elevator car after the elevator car has not been used for a certain time (sleep mode) while the door opening button continues to be monitored in order to avoid that a passenger gets trapped inside the elevator car. That is, by providing the door opening signal first the input unit gets activated to provide drive signals. Providing drive commands (and drive signals) to two different floors will lead to a movement of the elevator car in any case, even if, by chance, the elevator car is at the first floor at the beginning of the process.

After a providing the operational commands and causing the activation of the corresponding operational signals the activation controller may be configured to reset (reset step 560) to the predetermined default state, possibly after a predetermined delay time period. As noted above, the activation controller may be configured to only initiate the generating of the at least one operational signal when the activation controller is in the default state. Therefore, according to this example, any (new) trigger signal received at the activation controller is ignored by the activation controller during the activation (generation) of the at least one operational signal.

In reaction to the access command 550 for enabling access to the elevator car activation of the access signal 562 for enabling access to the elevator car is caused allowing the elevator car to be operated. The access stays enabled until the access signal 564 for disabling access to the elevator car is caused in reaction to the access command 558 for disabling access to the elevator car.

As shown, in reaction to the door opening command 552 activation of the door opening signal 566 is caused, in reaction to the drive command 554 for the first floor activation of the drive signal 572 for the first floor is caused, and in reaction to the drive command 556 for the second floor activation of the drive signal 574 for the second floor is caused.

In response to the door opening signal 566 doors (of the elevator car itself and the floor at which the elevator car is located) of the elevator system may (when operating properly) start to open and be completely open at time 568, at which time a corresponding detection signal, such as a door open detection signal 570 indicating that the doors are open, may be generated by door sensors. This detection signal (door open signal 570) may then be transmitted to the main controller, which is connected to the door sensor via a sensor input, within the first monitoring time period 546. If the doors fail to open (not shown), no detection signal (door open detection signal) will be received by the main controller within the first monitoring time period 546.

In response to the drive signal 572 for the first floor or in any case, including the case that the elevator car is already at the first floor when the drive signal 572 for the first floor is activated, in response to the drive signal 574 for the second floor the elevator car starts moving, i.e. a car movement 576 occurs. The car movement 576 leads to a corresponding detection signal, such as a car movement detection signal 578, of the car position indicator, which is transmitted to the main controller. The car movement detection signal 578 is received at the main controller via its sensor inputs within the second monitoring time period 548 in the example shown in FIG. 5. If the elevator car fails to move (not shown), no detection signal (car movement detection signal) will be received by the main controller within the second monitoring time period 548.

In the example shown in FIG. 5 it is assumed that the elevator system is operating correctly without failure, thus, the opening of the door and the car movement are detected within the first monitoring time period 546 and the second monitoring time period 548, respectively. In that case main controller may output a success message 580 (e.g. to the elevator controller of the elevator system) and optionally send the success message to a remote computing entity. In case the opening of the door or the car movement are not detected within the respective monitoring time periods, at least one of a first error message, a second error message, and a combined error message may be output and optionally sent to the remote computing entity (as described in relation to FIG. 4A).

Further, the dead time, the first and second monitoring time periods may be reset in a reset step 582.

It will be appreciated by those skilled in the art that the disclosure has been illustrated by describing one or more specific examples thereof, but is not limited to these examples; many variations and modifications are possible, within the scope of the accompanying claims.

What is claimed is:

1. A stimulation system (301) for monitoring an elevator system, the elevator system having an elevator car (103, 203) with an input unit (230, 330) for providing operational signals to an elevator controller (115) of the elevator system and having sensors (243, 245) for detecting an operating state of the elevator car (203) and outputting corresponding detection signals, the stimulation system (301) comprising:
a main controller (302) having a trigger output (312) for sending trigger signals and configurable to receive the detection signals from the sensors; and
an activation controller (304) connectable to the input unit of the elevator car and having a trigger input (316) for receiving trigger signals, the trigger input connected to the trigger output of the main controller;
wherein the activation controller (304) is configured to, when connected to the input unit,
cause (454, 458, 462, 466, 468), in response to a trigger signal (406) received on the trigger input, activation of predetermined operational signals (562, 564, 566, 572, 574) at the input unit; and
wherein the main controller (302) is configured to, when configured to receive the detection signals from the sensors,
send (404) the trigger signal over the trigger output, and
determine (410, 414) based on the detection signals whether at least one change of the operating state occurs in accordance with the at least one predetermined operational signal.

2. The stimulation system of claim 1, wherein the main controller (302) is further configured to, when configured to receive the detection signals from the sensors,
determine (402) based on the detection signals, that since the last use of the elevator car a specified dead time has elapsed;
send the trigger signal when it is determined that the specified dead time has elapsed since the last use.

3. The stimulation system of claim 1, wherein the activation controller (302) is configured to, when connected to the input unit, cause the activation of some or all of the predetermined operational signals in a predetermined sequence such that between each two consecutive of the operational signals of the predetermined sequence a respective delay time period is present.

4. The stimulation system of claim 1, wherein the activation controller (304) comprises a delay circuit (320) connected to the trigger input and activation elements (318a, 318b, 318c, . . . 318n) connected to the delay circuit; the activation elements connectable to the input unit; wherein the delay circuit is configured to generate operational commands (550, 552, 554, 556, 558) in response to receiving the trigger signal (544); wherein each operational command changes a state of one of the activation elements such that, when connected to the input unit, activation of a corresponding one of the operational signals is caused; and wherein at least one of the operational commands is generated with a time delay with respect to the trigger signal.

5. The stimulation system of claim 4, wherein at least two of the at least one of the operational commands generated with time delay with respect to the trigger signal are generated with different time delays with respect to the trigger signal.

6. The stimulation system of claim 1, wherein the at least one predetermined operational signal comprises one or more of a door opening signal (566), a drive signal (572) to a first floor, a drive signal (574) to a second floor different from the first floor, an access signal (562) for enabling access to the elevator car, and an access signal (564) for disabling access to the elevator car.

7. The stimulation system of claim 6, wherein the at least one predetermined operational signal comprises the door opening signal and at least one of the drive signal to the first floor and the drive signal to the second floor; wherein the activation controller is configured to cause the activation of the door opening signal prior to the activation of the at least one of the drive signal to the first floor and the drive signal to the second floor.

8. The stimulation system of claim 1, wherein the main controller (302) comprises at least one sensor input (310) connectable to one or more sensors, the sensors optionally comprising one or more of at least one door sensor (245), and at least one car position indicator (243).

9. The stimulation system of claim 1, wherein each of the at least one change of the operating state is associated with one or more of the at least one predetermined operational signals.

10. The stimulation system of claim 1, wherein the main controller (302) is further configured to
generate an error message, when it is determined that the at least one change of the operating state does not occur in accordance with the at least one predetermined operational signal; and,
optionally, send the error message to a remote computing entity.

11. The stimulation system of claim 10, wherein the error message includes information as to which one of the at least one change in the operating state did not occur.

12. The stimulation system of claim 1, wherein the main controller (302) is further configured to
generate a success message, when it is determined that the at least one change of the operating state does occur in accordance with the at least one predetermined operational signal; and,
optionally, send the success message to a remote computing entity.

13. The stimulation system of claim 1, wherein the at least one change of the operating state includes a first change of the operating state and a second change of the operating state; wherein the main controller is further configured to, when configured to receive the detection signals from the sensors,
monitor, after sending the trigger signal, the detection signals for a specified first monitoring time period (546) whether the first change of the operating state occurs;
monitor, after sending the trigger signal, the detection signals for a specified second monitoring time period (548) whether the second change of the operating state occurs, wherein the second monitoring time period is longer than the first monitoring time period;
determine, when the first change of the operating state does not occur during the first monitoring time period, that the first change of the operating state occurs not in accordance with the at least one predetermined operational signal, and stop monitoring whether the second change of the operating state occurs.

14. An elevator system comprising an elevator controller (115) and an elevator car (103, 203), the elevator car comprising an input unit for providing operational signals to the elevator controller, the elevator system having sensors for detecting an operating state of the elevator car and outputting corresponding detection signals; the elevator system further comprising a stimulation system according to claim 1; wherein the main controller is configured to receive the detection signals and the activation controller is connected to the input unit.

15. Stimulation method for monitoring an elevator system, which has an elevator car (103, 203) having an input unit (230, 330) for providing operational signals to an elevator controller (115) and which has sensors (243, 245) for detecting an operating state of the elevator car and outputting corresponding detection signals, the method comprising
sending (404), by a main controller (302), a trigger signal (406);
receiving, by an activation controller (304), the trigger signal (406);
causing (454, 458, 462, 466, 468), by the activation controller (304), activation of predetermined operational signals (562, 564, 566, 572, 574) at the input unit in response to the trigger signal (406);
receiving, by the main controller (302), the detection signals from the sensors; and
determining (410, 414), by the main controller (302), based on the detection signals whether at least one change of the operating state occurs in accordance with the at least one predetermined operational signal.
